(19) United States
(12) Patent Application Publication
(10) Pub. No.: US 2006/0193234 A1
(43) Pub. Date: Aug. 31, 2006

(54) Optical pick-up apparatus and optical disk apparatus incorporating the optical pick-up apparatus

(75) Inventor: Chikara Tanioka, Kawasaki-City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Samsung Storage Technology Corporation, Kawasaki-city (JP)

(21) Appl. No.: 11/317,022

(22) Filed: Dec. 27, 2005

(30) Foreign Application Priority Data
Dec. 28, 2004 (JP) JP2004-381932
Sep. 5, 2005 (JP) JP2005-256817

(51) Int. Cl. G11B 7/00

(52) U.S. Cl. 369/110.04

(57) ABSTRACT

An exemplary optical pick-up apparatus of the invention includes: a first light source configured to emit a light beam of a first wavelength; a second light source configured to emit a light beam of a second wavelength, the second wavelength longer than the first wavelength; a third light source configured to emit a light beam of a third wavelength, the third wavelength longer than the second wavelength, wherein the first, second, and third light sources emit light beams one at a time during a reading or writing operation; a first dichroic element configured to transmit the light beam of the first wavelength and to reflect the light beam of the second wavelength; a second dichroic element configured to reflect the light beams of the first and second wavelengths and to transmit the light beam of the third wavelength; and an objective lens configured to transmit light beams of the first and second wavelengths, that have interacted with the first and second dichroic elements, to transmit the third wavelength, that has interacted with the second dichroic element, and to project one light beam onto a disk.

### CROSS-REFERENCE TO RELATED APPLICATIONS

This application is based upon and claims the benefits of priority under 35 U.S.C. §119 from the Japanese Patent Application 2004-381932, filed Dec. 28, 2004, and Japanese Patent Application 2005-256817, filed Sep. 5, 2005, the contents of both of which are hereby incorporated by reference in their entirety.

### BACKGROUND OF THE INVENTION

1. Field of the Invention

The present invention relates to an optical pick-up apparatus including an optical system compatible with CDs, DVDs, HD-DVDs, and to an optical disk apparatus incorporating the optical pick-up apparatus.

2. Description of the Related Art

An optical pick-up device compatible with HD-DVDs, DVDs, and CDs is described, for example, in chapter 5 of “Pick-up arrangement,” written by Kiyono Ikenaka at page 29 of Microoptics Study Group Journal, Vol. 22, No. 3, p25-29 (issued September 2004).

According to the optical pick-up arrangement described in the above-noted reference publication, a polarization beam splitter for splitting a light beam in a light transmission/reception system or a half mirror is disposed right after a DVD LD (Laser Diode) and the light beam from the polarization beam splitter or half mirror is combined with a light beam from an HD-DVD LD. Furthermore, the light beam from the HD-DVD LD is never reflected and is focused onto an optical disk.

However, according to the optical pick-up arrangement described in the above-noted publication, the polarization beam splitter for splitting a light beam in the light transmission/reception system or the half mirror is provided. When the half mirror is employed, the efficiency of an optical system is reduced. In the case of a polarization optical system employing a polarization beam splitter, a light-combining device for combining a light beam with the light beam from the DVD LD increases the complexity of the system with respect to polarization and wavelength. Therefore, it is considered to be virtually impossible to put the above-described system into practice. Furthermore, in the above-mentioned structure, the entire optical system is large in length and cannot be housed in a compact optical pick-up apparatus.

### BRIEF SUMMARY OF THE INVENTION

As described above, there is a problematic situation where the conventional optical pick-up apparatus, that is compatible with HD-DVDs, DVDs, and CDs, has a highly complex arrangement of optical components and cannot be housed in a compact optical pick-up apparatus.

The present invention is made in consideration of problems in the above-described conventional optical pick-up apparatus, that is compatible with HD-DVDs, DVDs, and CDs. An object of the present invention is to provide an optical pick-up apparatus that reduces the complexity in the arrangement of high-performance optical components and can be housed in a compact optical pick-up apparatus. An additional object of the present invention is to provide an optical disk apparatus incorporating the optical pick-up apparatus.

According to one aspect of the invention, an optical pick-up apparatus includes: a first light source configured to emit a light beam of a first wavelength; a second light source configured to emit a light beam of a second wavelength, the second wavelength longer than the first wavelength; a third light source configured to emit a light beam of a third wavelength, the third wavelength longer than the second wavelength, wherein the first, second, and third light sources are configured to emit light beams one at a time during a reading or writing operation; a first dichroic element configured to transmit the light beam of the first wavelength and to reflect the light beam of the second wavelength; a second dichroic element configured to reflect the light beams of the first and second wavelengths and to transmit the light beam of the third wavelength; and an objective lens configured to transmit light beams of the first and second wavelengths, that have interacted with the first and second dichroic elements, to transmit the third wavelength, that has interacted with the second dichroic element, and to project one light beam onto a disk.

According to a non-limiting example of the present invention, an optical pick-up apparatus can be provided that further reduces the complexity in the arrangement of high-performance optical components and can be housed in a sophisticated and compact optical pick-up apparatus. Furthermore, an optical disk apparatus incorporating the optical pick-up apparatus can be provided.

### BRIEF DESCRIPTION OF THE DRAWINGS

A more complete appreciation of the embodiments of the present invention, and many of the attendant advantages thereof, will be understood by reference to the following detailed description, when considered in connection with the accompanying drawings, wherein:

FIG. 1 is a diagram showing an exemplary configuration of an embodiment of an optical pick-up apparatus according to the present invention;

FIG. 2 is an explanatory diagram of how a light beam is incident on and reflected by a second dichroic element of the embodiment of the present invention; and

FIG. 3 is an explanatory diagram of how a light beam is incident on and reflected by a first dichroic element of the embodiment of the present invention.

### DETAILED DESCRIPTION OF PREFERRED EMBODIMENTS

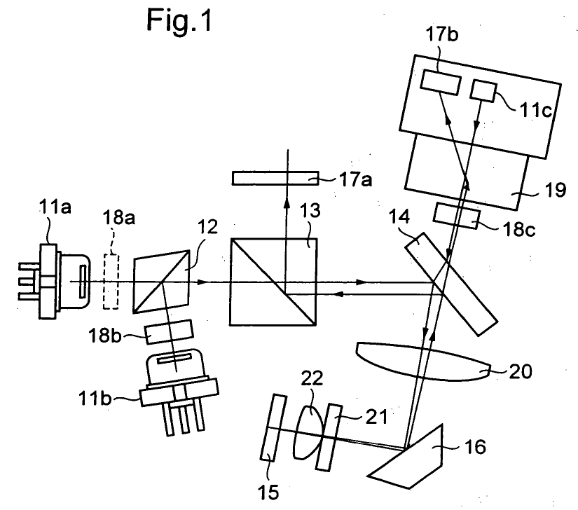

An embodiment of the present invention will be explained below with reference to the accompanying drawings. FIG. 1 is an exemplary configuration of an embodiment of an optical pick-up apparatus according to the present invention. An optical disk apparatus is provided with the optical pick-up apparatus for focusing laser beams originating from laser diodes 11a, 11b, and 11c onto a surface of an optical disk 15 in order to record and reproduce information. The optical pick-up apparatus includes: laser diodes 11a, 11b, and 11c as light sources, which emit light beams of three different wavelengths; a first dichroic element 12, such as a dichroic prism, including a dichroic thin film for transmitting a light beam emitted from the laser diode 11a and reflecting a light beam emitted from the laser diode 11b; a polarization beam splitter 13 for transmitting a light beam exiting the first dichroic element 12; and a second dichroic element 14, such as a dichroic mirror, including a dichroic thin film for reflecting a light beam passing through the polarization beam splitter 13 and transmitting a light beam emitted from the laser diode 11c. A dichroic thin-film dielectric stack is used as the dichroic thin film.

The optical pick-up apparatus further includes: a launching mirror 16 for reflecting light beams reflected by and passing through the second dichroic element 14 to the disk 15 and reflecting again a light beam reflected from the disk 15 to the second dichroic element 14; and a first optical detector 17a for receiving a light beam reflected by the polarization beam splitter 13 after the light beam from the disk 15 is reflected by the launching mirror 16, reaches the second dichroic element 14, and is reflected by the second dichroic element 14. The optical pick-up apparatus further includes: a combination lens 18b interposed between the laser diode 11b and the first dichroic element 12; light splitting device 19 including, for example, a hologram, and a combination lens 18c interposed between the laser diode 11c and the second dichroic element 14; a collimator lens 20 interposed between the second dichroic element 14 and the launching mirror 16; and an optical member 21 and an objective lens 22 interposed between the launching mirror 16 and the disk 15, in which the optical member 21 includes a polarizing element, such as quarter-wave plate or polarization hologram, and a wavelength-selective and numerical aperture limiting element.

In an optical pick-up apparatus capable of detecting light beams of three wavelengths used for HD-DVD/DVD/CD read/write operations, i.e., compatible with HD-DVDs, DVDs, and CDs, light beams emitted from three laser diodes 11a, 11b, and 11c need to be guided to one objective lens 22. In this case, it is required to keep the amount of wavefront aberration purposely low and the utilization ratio of light beam purposely high. Furthermore, in slim-type optical pick-up, this is required to reduce the size of an entire optical system as much as possible.

In this embodiment of the present invention, these requirements are met as follows. This embodiment will be explained with reference to FIG. 1 showing the configuration of the slim-type optical pick-up.

The laser diode 11a as a first light source emits a light beam having a wavelength of 405 nm for the HD-DVD. The light beam emitted from the laser diode transmits the first dichroic element 12 and the polarization beam splitter 13.

In general, when optical components of glass are employed, the amount of wavefront aberration in a case of a light beam being transmitted through a glass optical component is reduced as compared to a case in which the light beam is reflected from the glass optical component. Therefore, the optical system allowing a light beam to be transmitted through the first dichroic element 12 and the polarization beam splitter 13 is used for an HD-DVD optical system that is chosen out of the three optical systems (i.e., HD-DVD, DVD, and CD optical systems) of interest in terms of a requirement to keep the wavefront aberration low.

The light beam, after being transmitted through the polarization beam splitter 13, is then reflected by the second dichroic element 14. In order to house the entire optical system in the slim-type optical pick-up, the HD-DVD optical system having an optical magnification factor of greater than that of a Compact Disk (CD) optical system uses reflection by the second dichroic element 14.

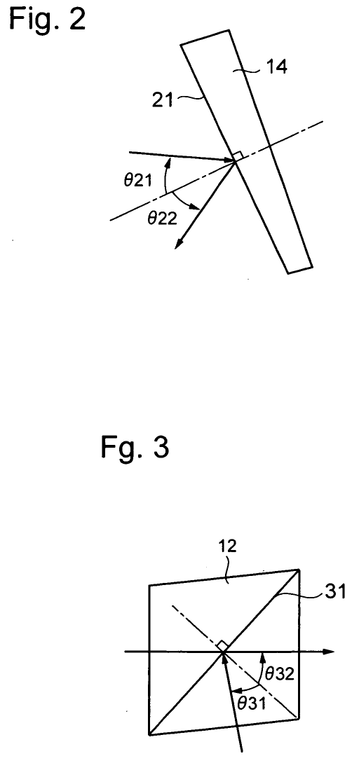

As shown in FIG. 2, the second dichroic element 14 is wedge-shaped and an incident angle θ 21 of the light beam, relative to the normal of a reflecting surface 21, is preferably set to be no greater than 40 degrees in terms of minimizing the chance of introduction of high order aberration at the location of the CD optical system and in consideration of the refraction properties of a dichroic film. Accordingly, in this case, an outgoing angle θ 22 of the light beam, relative to the normal of the reflecting surfaces is also set to be no greater than 40 degrees.

In this manner, effects of the introduction of high order aberration at the location of the CD optical system can be suppressed and the light beam of a first wavelength can be reflected with a high reflection coefficient by the second dichroic element 14. The light beam reflected by the second dichroic element 14 then transmits the collimator lens 20 and is reflected by the launching mirror 16. The linearly polarized light beam reflected by the launching mirror 16 is converted to a circularly polarized light beam by the quarter-wave plate of the optical member 21. The circularly polarized light beam is then transmitted through the objective lens 22, whose numerical aperture is suitably controlled by the wavelength-selective and numerical aperture limiting element so as to vary depending on wavelength, to the disk 15. Then, the light beam reflected from the disk 15 follows a forward path. That is, the light beam reflected from the disk is transmitted through the objective lens 22 and the optical member 21, is reflected by the launching mirror 16, is transmitted through the collimator lens 20, and is reflected by the second dichroic element 14 to the polarization beam splitter 13, which however, in turn reflects the light beam to the first optical detector 17a. The numerical aperture limiting element limits the numerical aperture of the object lens 22 in order to reduce the numerical aperture of the object lens 22 when the wavelength of the light beam becomes long.

Furthermore, the laser diode 11b, as a second light source, emits a light beam having a wavelength of 655 nm for use with the DVD. The light beam emitted from the diode passes through the combination lens 18b and is first reflected by the first dichroic element 12.

As shown in FIG. 3, the first dichroic element 12 is wedge-shaped and an incident angle θ 31 and a reflecting angle θ 32 of the light beam, both relative to the normal of the reflecting surface, are preferably set to be no greater than 40 degrees. This is done to minimizing the chance of an introduction of a wave aberration at the time of transmission of the light beam emitted from the first light source and in consideration of the refraction properties of a dichroic film. In this manner, effects of the introduction of wave aberration at the time of transmission of the light beam of the first wavelength can be suppressed and the light beam of the second wavelength can be reflected with a high reflection coefficient.

Then, the light beam reflected by the first dichroic element 12 travels along substantially the same path as the light beam emitted by the above-mentioned HD-DVD laser diode 11a. That is, the light beam reflected by the first dichroic element is transmitted through the polarization beam splitter 13, is reflected by the second dichroic element 14, is transmitted through the collimator lens 20, is reflected by the launching mirror 16, passes through the optical member 21 and the objective lens 22, and is irradiated onto the disk 15. The light beam reflected from the disk 15 again passes through the objective lens 22, pass through the optical member 21, is reflected by the launching mirror 16, is transmitted through the collimator lens 20, is reflected by the second dichroic element 14, is reflected by the polarization beam splitter 13, and enters the first optical detector 17a.

The first optical detector 17a is for detecting an optical signal reflected from the disk and used to produce a RF signal, focusing signal, tracking signal, etc., when the disk 15 is accessed to record data and accessed to reproduce an original signal. Optical detector 17a is commonly used in detecting optical signals reflected from the disk that are light beams that originate from HD-DVD and DVD laser diodes.

Furthermore, the quarter-wave plate, a light polarizing element of the optical member 21, could be replaced by a polarizing hologram having an operating wavelength range including the first and second wavelengths.

The laser diode 11c as a third light source, the second optical detector 17b, and the light splitting device 19 are integrated into a combined light splitting device and laser unit. The laser diode 11c emits a light beam having a wavelength of 785 nm for the CD. The light beam passes through the light splitting device 19 for splitting a light beam to direct a portion of the energy of this light beam to the second optical detector 17b when the light beam is reflected from the disk 15. The light beam emitted from laser diode 11c is transmitted and passes through the combination lens 18c, and is then transmitted through the second dichroic element 14.

The light beam transmitted through the second dichroic element 14 passes through the collimator lens 20 and strikes the launching mirror 16, passes through the optical member 21, passes through the objective lens 22 so as to be focused onto the disk 15 which, in this example, is a compact disk. The light beam reflected from the disk 15 follows a forward path. That is, for example, the combined light splitting device and laser unit is used as shown in FIG. 1, the reflected light beam is diffracted in this unit and enters the second optical detector 17b disposed near the laser diode 11c. The second optical detector 17b detects an optical signal reflected from the disk 15 and uses the detected optical signal to produce a RF signal, focusing signal, tracking signal, etc., when the disk 15 that receives a light beam from a CD diode is accessed to record data and accessed to reproduce an original signal.

As described in connection with the explanation of the optical path of the light beam from the first light source, the linearly polarized light beam is converted to the circularly polarized light beam by the quarter-wave plate that is a light polarizing element of the optical member 21. The circularly polarized light beam is transmitted through the objective lens 22, whose numerical aperture is suitably controlled by the wavelength-selective numerical aperture limiting element so as to vary depending on wavelength, onto the disk 15. Therefore, it is needless to say that an optical path along which the light beams from the second light source and the third light source travel to the disk is the same as that for the light beam from the first light source. The light polarizing element such as quarter-wave plate polarizes each light beam of the first, second and third wavelengths.

In this embodiment, since the combination lens 18b is interposed between the laser diode 11b and the first dichroic element 12, the magnification factor of an optical system capable of transmitting a light beam of a second wavelength in a forward direction can be different than that of an optical system capable of transmitting a light beam of a first wavelength in a forward direction. Furthermore, since the combination lens 18c is interposed between the laser diode 11c and the second dichroic element 14, the magnification factor of a light optical system capable of transmitting a light beam of a third wavelength in a forward direction can be changed. Moreover, it can be contemplated that a combination lens 18a is also interposed between the laser diode 11a and the first dichroic element 12. In this case, similarly to the case where the combination lens 18b is interposed between the laser diode 11b and the first dichroic element 12, the magnification factor of an optical system capable of transmitting a light beam of a first wavelength in a forward direction can be different than that of an optical system capable of transmitting a light beam of a second wavelength in a forward direction.

According to the aforementioned embodiment of the present invention, an enhanced, compact optical pick-up apparatus capable of generating, from a laser beam emitted from a laser diode, a beam spot used for recording information to and reproducing information from a recording medium, and capable of detecting light beams of three wavelengths used for HD-DVD/DVD/CD read/write operations can be provided. In addition an optical disk apparatus equipped with the optical pick-up apparatus can be provided.

More specifically, when light beams emitted from three laser diodes 11a, 11b, are 11c are guided to one objective lens 22, it is crucial to keep the amount of wavefront aberration purposely low and the utilization ratio of light energy purposely high. Accordingly, in the above embodiment, an HD-DVD optical system consists of an optical system allowing a light beam to transmit the first dichroic element 12 and the polarizing beam splitter 13. Therefore, the wavefront aberration becomes small and the utilization ratio of light energy purposely can be kept high.

Furthermore, in a slim-type optical pick-up, the entire optical system is required to be small in size in order to allow the pick-up to house the optical system. According to the above embodiment, reflecting a light beam by the second dichroic element 14 is used in the HD-DVD optical system having a large optical magnification factor. Therefore, the entire optical system can be reduced in size as compared to an optical system of the compact disk (CD).

Moreover, according to the above embodiment, the first optical detector 17a for detecting an optical signal reflected from the disk 15 is commonly used to detect optical signals reflected from the disk that reflects laser beams from the HD-DVD laser source and the DVD laser source. Therefore, the number of optical detectors can be reduced to two. That is, only the above-described first optical detector 17a and the second optical detector 17b, for detecting a light beam from the CD laser source, are incorporated in the optical pick-up apparatus capable of detecting light beams of three wavelengths used for HD-DVD/DVD/CD read/write operations.

The above-described optical pick-up apparatus is applicable to an optical disk apparatus capable of generating, from a laser beam emitted from a laser diode, a beam spot used for recording information to and reproducing information from a recording medium.

Numerous modifications and variations of the present invention are possible in light of the above-teachings. It is therefore to be understood that within the scope of the appended claims, the invention may be practiced otherwise than as specifically described herein.

What is claimed is:

1. An optical pick-up apparatus comprising:
a first light source configured to emit a light beam of a first wavelength;
a second light source configured to emit a light beam of a second wavelength, the second wavelength longer than the first wavelength;
a third light source configured to emit a light beam of a third wavelength, the third wavelength longer than the second wavelength, wherein the first, second, and third light sources are configured to emit light beams one at a time during a reading or writing operation;
a first dichroic element configured to transmit the light beam of the first wavelength and to reflect the light beam of the second wavelength;
a second dichroic element configured to reflect the light beams of the first and second wavelengths and to transmit the light beam of the third wavelength; and
an objective lens configured to transmit light beams of the first and second wavelengths, that have interacted the first and second dichroic elements, to transmit the third wavelength, which has interacted with the second dichroic element, and to project a light beam onto a disk.

2. The optical pick-up apparatus according to claim 1, further comprising a numerical aperture limiting element configured to limit a numerical aperture of the objective lens, a size of the numerical aperture corresponding to the wavelength of the light beam projected onto the disk.

3. The optical pick-up apparatus according to claim 1, further comprising:
a polarizing beam splitter interposed between the first dichroic element and the second dichroic element;
a first optical detector configured to receive a light beam reflected by the polarizing beam splitter; and
a light polarizing element configured to polarize each light beam of the first, second, and third wavelengths.

4. The optical pick-up apparatus according to claim 3, further comprising:
a light splitting device configured to split the light beam of the third wavelength emitted from the third light source and reflected from the disk; and
a second optical detector configured to receive the split light beam.

5. The optical pick-up apparatus according to claim 1, further comprising a first combination lens interposed between the first light source and the first dichroic element.

6. The optical pick-up apparatus according to claim 1, further comprising a second combination lens interposed between the second light source and the first dichroic element.

7. The optical pick-up apparatus according to claim 1, further comprising a third combination lens interposed between the second dichroic element and the third light source.

8. The optical pick-up apparatus according to claim 1, wherein the second dichroic element is wedge-shaped.

9. The optical pick-up apparatus according to claim 1, wherein the second dichroic element is configured so that an incident angle of the light beams of the first and second wavelengths, relative to the normal of a reflecting surface of the second dichroic element, is not greater than 40 degrees.

10. The optical pick-up apparatus according to claim 1, wherein the first dichroic element is configured so that an incident angle of the light beam of the second wavelength, relative to the normal of a reflecting surface of the first dichroic element, is not greater than 40 degrees.

11. The optical pick-up apparatus according to claim 3, wherein the polarizing element is one of a polarization hologram and a quarter-wave plate.

12. An optical pick-up apparatus comprising:
a first light source configured to emit a light beam of a first wavelength;
a second light source configured to emit a light beam of a second wavelength, the second wavelength longer than the first wavelength;
a third light source configured to emit a light beam of a third wavelength, the third wavelength longer than the second wavelength, wherein the first second and third light sources are configured to emit light beams one at a time during a reading or writing operation;
a first dichroic element configured to transmit the light beam of the first wavelength and to reflect the light beam of the second wavelength;
a polarizing beam splitter with an operating wavelength range that includes the first and second wavelengths;
a second dichroic element configured to reflect the light beams of the first and second wavelengths and to transmit the light beam of the third wavelength;
a collimator lens configured to transmit a light beam reflected by the second dichroic element and a light beam transmitted through the second dichroic element;
an objective lens configured to transmit a light beam that has passed through the collimator lens and that has one of the first, second, and third wavelengths, and to project the a light beam onto a disk;
a light polarizing element configured to polarize a light beam of either the first, second, or third wavelengths, the light polarizing element includes a numerical aperture limiting element configured to limit a numerical aperture of the objective lens, the size of the numerical aperture corresponding to a wavelength of a light beam interacting with the light polarizing element;
a first optical detector configured to receive light beams that have the first and second wavelengths, and that have been reflected by the first dichroic element and the second dichroic element after being reflected from the disk;
a light splitting device configured to split a light beam that has the third wavelength and that has been transmitted through the second dichroic element after being reflected from the disk; and
a second optical detector configured to receive a light beam split by the light splitting device.

13. The optical pick-up apparatus according to claim 12, wherein the third light source, the light splitting device, and the second optical detector are integrated into one unit.

14. An optical disk apparatus comprising an optical pick-up apparatus, according to claim 4, configured to generate, from a laser beam emitted from a laser diode, a beam spot used for recording information to and reproducing information from a recording medium.

15. An optical disk apparatus comprising an optical pick-up apparatus, according to claim 12, configured to generate, from a laser beam emitted from a laser diode, a beam spot used for recording information to and reproducing information from a recording medium.

16. A method of reproducing information on a machine readable medium, comprising steps of:
emitting one of a light beam of a first wavelength from a first light source, a light beam of a second wavelength from a second light source, the second wavelength longer than the first wavelength, and a light beam of a third wavelength from a third light source, the third wavelength longer than the second wavelength;
if the light beam of the first wavelength is emitted, then transmitting the light beam of the first wavelength through a first dichroic element;
if the light beam of the second wavelength is emitted, then reflecting the light beam of the second wavelength with the first dichroic element;
if the light beam of the first wavelength is emitted, then reflecting the light beam of the first wavelength with a second dichroic element;
if the light beam of the second wavelength is emitted, then reflecting the light beam of the second wavelength with the second dichroic element;
if the light beam of the third wavelength is emitted, then transmitting the light beam of the third wavelength through the second dichroic element;
projecting a light beam with either the first, second, or third wavelength onto a disk with an objective lens.

17. The method of claim 16, further comprising a step of limiting a numerical aperture of the objective lens, such that a size of the numerical aperture corresponds to the wavelength of the light beam projected onto the disk.

18. The method of claim 16, further comprising steps of:
receiving a light beam with either the first, second or third wavelength at a first optical detector which was reflected by a polarizing beam splitter, the polarizing beam splitter being interposed between the first dichroic element and the second dichroic element; and
polarizing the light beam with either the first, second, or third wavelength with a light polarizing element.

19. The optical pick-up apparatus according to claim 18, further comprising steps of:
if the light beam with the third wavelength is emitted, then splitting the light beam of the third wavelength emitted from the third light source and reflected from the disk with a light splitting device; and
receiving the split light beam with a second optical detector.

20. The method of claim 16, wherein a first combination lens is interposed between the first light source and the first dichroic element.
